(19) United States
(12) Patent Application Publication
(10) Pub. No.: US 2006/0197743 A1
(43) Pub. Date: Sep. 7, 2006

(54) Editing apparatus and editing processing program

(75) Inventors: Yoshihiro Yoshioka, Kanagawa (JP); Mitsuko Honma, Kanagawa (JP); Tadayoshi Itani, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/362,100

(22) Filed: Feb. 27, 2006

(30) Foreign Application Priority Data
Mar. 2, 2005 (JP) 2005-056819

(51) Int. Cl. G09G 5/08

(52) U.S. Cl. 345/157

(57) ABSTRACT

An editing apparatus and an editing processing program are disclosed wherein an interface having a high degree of fidelity to the sense of a human being is implemented in parameter adjustment performed using a graduation display section. When an operator uses an inputting section to operate a pointer displayed on a screen, the adjustment amount for a parameter is determined from the operation amount of the inputting section. Then, the movement amount for a knob display of a graduation display section is determined in accordance with the adjustment amount for the parameter. Then, the movement amount for the pointer is decided in accordance with the movement amount for the knob display. Therefore, when the operator moves the knob display to adjust the parameter, the movement amount for the pointer can be decided in accordance with the adjustment amount for the parameter.

### CROSS REFERENCES TO RELATED APPLICATIONS

The present invention contains subject matter related to Japanese Patent Application JP 2005-056819 filed with the Japanese Patent Office on Mar. 2, 2005, the entire contents of which being incorporated herein by reference.

### BACKGROUND OF THE INVENTION

This invention relates to an editing apparatus and an editing processing program wherein a parameter of an object of editing is adjusted depending upon the position of a knob display of a graduation display section displayed on a screen.

Various devices such as a mouse, a track ball, a joystick and a jog dial are conventionally used as inputting apparatus for operating a pointer displayed on a screen. An operator would use such devices to operate the pointer on the screen to perform such operations as movement, reduction and enlargement of a window or an object of editing displayed on the screen or adjustment of various parameters. Editing apparatus which use such devices as just mentioned are disclosed, for example, in Japanese Patent Laid-open No. Hei 7-38842 (hereinafter referred to as Patent Document 1), Japanese Patent Laid-open No. Hei 10-290416 (hereinafter referred to as Patent Document 2) and Japanese Patent Laid-open No. Hei 11-185456 (hereinafter referred to as Patent Document 3).

### SUMMARY OF THE INVENTION

However, where such devices as mentioned above are used to decide a parameter for one operation, since the variation amount is decided uniquely depending upon the operation amount, in order to obtain a very small variation amount, a corresponding very small amount of operation is required, but in order to obtain a great variation amount, a corresponding great amount of operation is required.

In other words, in order to obtain a very small amount of variation, only a very small amount of operation is required. However, there is a limitation to fine adjustment from both of the operation of a human being and the capacity of the device. Further, in order to obtain a very great amount of variation, a very great amount of operation, that is, much continuous operation, is required, and this is difficult where the space or the operation amount is limited.

It is a desire of the present invention to solve the problems described above and provide an editing apparatus and an editing processing program are disclosed wherein an interface having a high degree of fidelity to the sense of a human being is implemented in parameter adjustment performed using a graduation display section.

In order to attain the desire described above, according to an embodiment of the present invention, there is provided an editing apparatus including an inputting section for operating the position of a pointer to be displayed on a screen, a detection section for detecting the operation amount of the inputting section by an operator, a graduation display section displayed on the screen and having a knob display which moves together with the pointer to adjust a parameter of an object of editing, an arithmetic operation section for deciding an amount of adjustment for the parameter based on the operation amount of the inputting section detected by the detection section, and a movement amount decision section for deciding an amount of movement for the knob display of the graduation display section in accordance with the amount of adjustment for the parameter determined by the arithmetic operation section and deciding an amount of movement for the pointer in accordance with the decided amount of movement.

In the editing apparatus, when the operator operates the pointer using the inputting section, the amount of adjustment for the parameter is determined from the operation amount of the inputting section, and then the amount of movement for the knob display of the graduation display section is determined in accordance with the adjustment amount for the parameter. Further, the amount of movement for the pointer is decided in accordance with the amount of movement for the knob display. Therefore, when the operator moves the knob display of the graduation display section to perform adjustment of the parameter, the amount of movement for the pointer can be decided in accordance with the amount of adjustment for the parameter.

In other words, not the amount of adjustment for the parameter by the knob display is decided in accordance with the amount of movement for the pointer, but the amount of adjustment for the parameter and the amount of movement for the knob display are decided from the operation amount of the inputting section and then the amount of movement for the pointer is decided in accordance with the amount of movement for the knob display. Therefore, the inputting section can be operated in accordance with the amount of adjustment for the parameter.

According to another embodiment of the present invention, there is provided an editing processing program for causing a computer to execute a process of performing adjustment of a parameter of an object of editing by allowing the position of a pointer displayed on a screen to be moved by means of an inputting section for being operated by an operator and moving a knob display of a graduation display section together with the movement of the pointer, including the steps of: detecting an operation amount of the inputting section by the operator; deciding an amount of adjustment for the parameter based on the operation mount of the inputting section detected by the process at the detection step; and deciding an amount of movement for the knob display of the graduation display section in accordance with the amount of adjustment for the parameter decided by the process at the decision step and deciding an amount of movement for the pointer in accordance with the decided amount of movement.

The editing processing program is executed when the operator uses the inputting section to move the knob display of the graduation display section. Then, in the editing processing program, the amount of adjustment for the parameter is determined from an operation amount of the inputting section operated by the user, and then the amount of movement for the knob display of the graduation display section is determined in accordance with the adjustment amount for the parameter. Further, the amount of movement for the pointer is decided in accordance with the amount of movement for the knob display. Therefore, when the operator moves the knob display of the graduation display section to perform adjustment of the parameter, the amount of movement for the pointer can be decided in accordance with the amount of adjustment for the parameter.

In other words, the editing processing program is executed in response to changeover from a normal operation mode in which the pointer is moved in response to an operation of the inputting section to another operation mode in which the knob display of the graduation display section is moved in response to an operation of the inputting section. Then, in the latter mode, not the amount of adjustment for the parameter by the knob display is decided in accordance with the amount of movement for the pointer, but the amount of adjustment for the parameter and the amount of movement for the knob display are decided from the operation amount of the inputting section and then the amount of movement for the pointer is decided in accordance with the amount of movement for the knob display. Therefore, the inputting section can be operated in accordance with the amount of adjustment for the parameter.

According to a further embodiment of the present invention, there is provided an editing apparatus including a graduation display section displayed on a screen and having a knob display which is moved to adjust a parameter of an object of editing, an inputting section for operating the position of the knob display of the graduation display section, a detection section for detecting an operation amount of the inputting section by an operator, an arithmetic operation section for deciding an amount of adjustment for the parameter based on the operation mount of the inputting section detected by the detection section, and a movement amount decision section for deciding an amount of movement for the knob display of the graduation display section in accordance with the amount of adjustment for the parameter decided by the arithmetic operation section, the arithmetic operation section deciding the amount of movement for the parameter in accordance with a rate corresponding to the amount of operation of the inputting section per a unit period of time.

In the editing apparatus, when the operator operates the graduation display section which performs adjustment of a parameter through movement of the knob display, the amount of adjustment for the parameter is decided with a rate corresponding to the operation amount of the inputting section per a unit period of time. Therefore, the operability of the operator can be enhanced by the rate corresponding to the range of the parameter by the graduation display section.

According to a still further embodiment of the present invention, there is provided an editing processing program for causing a computer to execute a process of performing adjustment of a parameter of an object of editing depending upon the position of a knob display on a graduation display section displayed on a screen as a result of movement of the knob display by means of an inputting section for being operated by an operator, including the steps of: detecting an operation amount of the inputting section by an operator; deciding an amount of adjustment for the parameter based on the operation mount of the inputting section per a unit period of time detected by the process at the detection step and deciding the amount of adjustment for the parameter in accordance with the rate; and deciding an amount of movement for the knob display of the graduation display section in accordance with the amount of adjustment for the parameter decided by the process at the decision step.

The editing processing program is executed when the operator uses the inputting section to move the knob display of the graduation display section. Then, in the editing processing program, when the operator performs adjustment of a parameter through movement of the knob display, the amount of adjustment for the parameter is decided with a rate corresponding to the operation amount of the inputting section per a unit period of time. Therefore, the operability of the operator can be enhanced by the rate corresponding to the range of the parameter by the graduation display section.

In summary, with the editing apparatus and the editing processing programs of the present invention, an interface having a high degree of fidelity to the sense of a human being can be provided in adjustment of the parameter performed through movement of the knob display of the graduation display section. Further, both of fine adjustment and adjustment by a great amount in change of the parameter can be implemented by an operation within a restricted operation range, that is, by one interface.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing an editing apparatus to which the present invention is applied;

FIG. 2 is a view illustrating an example of a table used in the editing apparatus of FIG. 1;

FIG. 3 is a similar view but illustrating a particular example of the table of FIG. 2;

FIG. 4 is a flow chart illustrating an editing processing program to which the present invention is applied;

FIG. 5 is a flow chart illustrating a particular flow of processes of the editing processing program of FIG. 4;

FIG. 6 is a schematic view showing an example of a screen display of an editing processing application to which the present invention is applied; and

FIG. 7 is an enlarged view of a slider for parameter adjustment displayed on the screen shown in FIG. 6.

### DETAILED DESCRIPTION OF THE PREFERRED EMBODIMENTS

In the following, a preferred embodiment of the present invention is described. In particular, an editing apparatus according to the embodiment is configured such that an operator operates an inputting section in the form of a pointing device such as a mouse, a track ball or a track pad to vary a predetermined parameter in accordance with the operation amount. The editing apparatus is wherein, when the operator moves a knob display on a graduation display section such as a slider displayed on a display unit through an operation of the inputting section to adjust a parameter, operability conforming to the sense of the operator can be achieved.

Usually, when an operator uses the inputting section to adjust a parameter, it is necessary for the operator to perform a slow operation when the operator wants to obtain a very small amount of variation but perform a quick operation when the operator wants to obtain a great amount of variation. In such an apparatus wherein the variation amount of a parameter is determined by an amount of movement (amount of operation) by a similar one operation as just described, the speed is additionally used as one of factors which determine the variation amount to achieve an interface having a higher degree of fidelity to the sense of a human being.

Generally, where the amount of movement (operation amount) of the inputting section performed within a fixed time period t by the operator is represented by M and the period of time within which the operator performs an operation to obtain a required variation amount by T, in the conventional method, the variation amount can be represented by variation amount=M×T. In other words, it is considered that the variation amount increases in proportion to the operation amount.

Here, the variation amount obtained by the conventional method is represented by V. In the present embodiment, a variation V′ is determined using the following technique.

(1) An operation speed s=M/t is calculated.

(2) The operation speed of the operator is measured and checked in advance among 1 to n stages, and a table is prepared wherein operation adjustment ratios v1 to vn which have an influence on an actual variation amount are coordinated with the operation speeds s1 to sn. The table is prepared in accordance with the operation of the operator such that the operation adjustment ratio at a reference speed si is set to 1, and the operation adjustment ratio when the operation speed is higher than the reference speed si is set to a higher value than 1 whereas the operation adjustment when the operation speed is lower than the reference speed si is set to a lower value than 1.

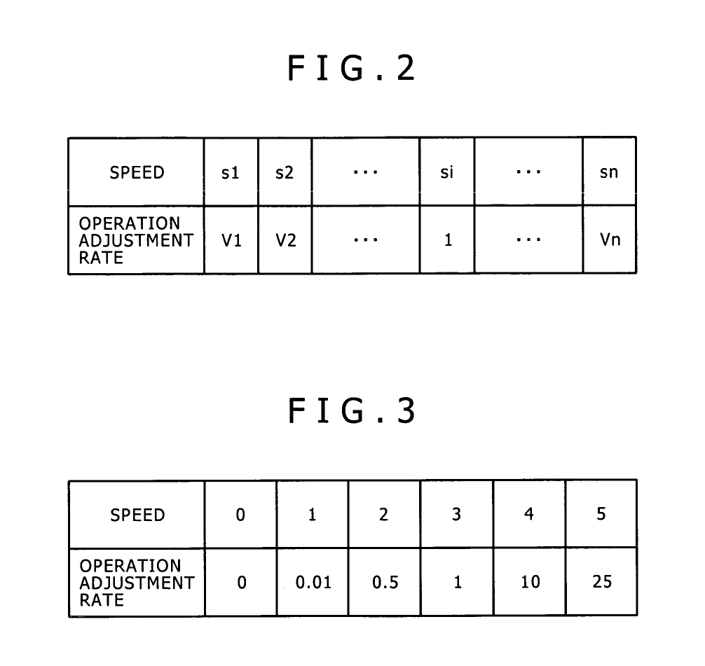

The table may be such as illustrated in FIG. 2.

It is assumed that s1<s2< . . . <si< . . . <sn and v1<v2< . . . <1< . . . <vn.

(3) The table illustrated in FIG. 2 is used to obtain vi from the speed s calculated as above, and the variation amount V obtained by the conventional method is multiplied by the resulting value vi to obtain V′. In other words,
V′=V×vi=M×T×vi

Further, if the fixed time period t is set to a low value to acquire the operation speed S finely, then change of the variation amount according to the variation of the operation speed of the user can be performed in a fine unit by any number of times by one operation of the user.

Further, if the table is prepared in accordance with an object of an operation, a purpose of the operation and a person (article) by whom the operation is performed based on the reference speed si, then the operation sense can be customized in accordance with the purpose or the object.

In a GUI (Graphical User Interface) or the like, since a difference appears between the variation amount determined from an actual operation amount and the variation amount determined using the mechanism described above, the actual variation amount is fed back to the position of a part of the GUI or the position of a mouse cursor.

### Particular Example

The reference speed si is set to si=3, and, for example, a table (Table A) illustrated in FIG. 3 which is prepared in order to perform a certain operation is assumed.

If an operation is performed at a speed (here, assumed to be 1) lower than the reference speed, the variation amount V according to the conventional system is V=1. However, the variation amount V′ in the present embodiment is V′=1×0.01=0.01. Therefore, in the present embodiment, even where the operation amount is equal, a variation of 1/100 can be obtained by performing an operation at a low speed.

Similarly, if an operation is performed at a speed higher than the reference speed, then a greater amount of variation can be obtained by the same amount of operation.

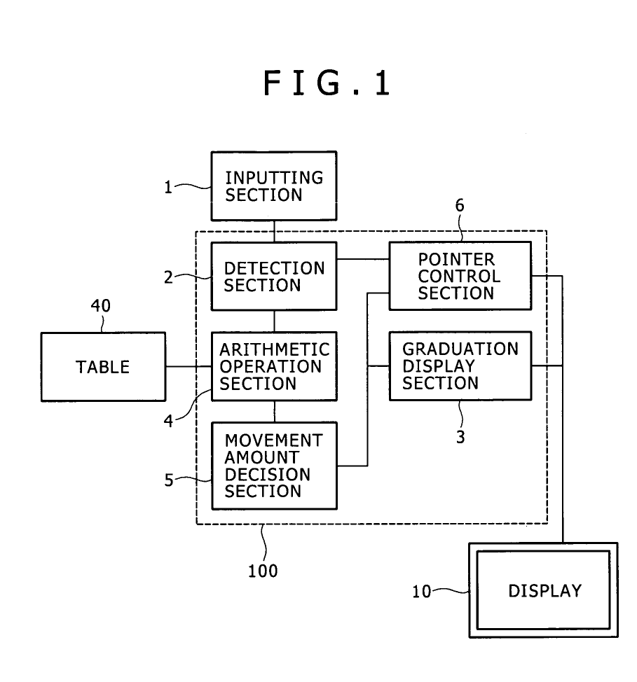

Now, a configuration of the editing apparatus according to the present embodiment is described. FIG. 1 shows in block diagram the editing apparatus according to the present embodiment. Referring to FIG. 1, the editing apparatus shown includes an inputting section 1 for operating the position of a pointer displayed on a display unit 10, a detection section 2 for detecting the operation amount of the inputting section 1 by an operator, and a graduation display section 3 for adjusting a parameter of an object of editing displayed on the display unit 10 through movement of a knob display. The editing apparatus further includes an arithmetic operation section 4 for determining an adjustment amount for a parameter based on the operation amount of the inputting section 1 determined by the detection section 2, and a movement amount decision section 5 for determining the amount of movement for the knob display of the graduation display section 3 in response to the adjustment amount for the parameter determined by the arithmetic operation section 4 and determining the amount of movement for the pointer in accordance with the determined amount of movement. The editing apparatus further includes a pointer control section 6 for controlling the movement of the pointer in response to an operation of the inputting section 1.

The inputting section 1 is operated (for example, rotationally or translationally) by the operator to move the pointer such as an arrow mark displayed on the display unit 10 to perform expansion, reduction or movement of a window, execution of various commands, change of a parameter and so forth. The inputting section 1 may be a pointing device such as, for example, a mouse, a track ball, a track pad or a jog dial.

The detection section 2 performs a process to detect the operation amount of the inputting section 1 by the operator and pass the detection operation amount to the pointer control section 6 and the arithmetic operation section 4. For example, where the inputting section 1 is formed from a mouse, the number of sampling pulses outputted from the mouse is counted to calculate the amount of movement (amount of operation) in the X and Y directions and passes the calculated amounts of movement to the arithmetic operation section 4 and the pointer control section 6.

The pointer control section 6 calculates the coordinates of the pointer on the display unit 10 from the operation amounts of the inputting section 1 passed thereto from the detection section 2 and controls the pointer so as to be moved to the coordinates. Consequently, the pointer on the screen moves following up the operation of the inputting section 1 by the operator.

The graduation display section 3 is a slider displayed on the display unit 10 and is a switch for adjustment of a parameter displayed by software. The graduation display section 3 includes a rail (graduation) portion which ranges from a minimum value to a maximum value of a parameter of an object of adjustment, and a knob display for moving on the rail to set the parameter within the range. The operator can operate the inputting section 1 to move the knob display on the rail to set the parameter corresponding to the position of the knob display on the rail.

The arithmetic operation section 4 performs arithmetic operation to determine an adjustment amount of a parameter based on an operation amount of the inputting section 1 passed thereto from the detection section 2. Accordingly, the arithmetic operation section 4 decides the parameter in accordance with the position of the knob display on the rail depending upon the range determined in accordance with the type of the graduation display section 3. Further, the arithmetic operation section 4 performs a process of deciding an adjustment amount for the parameter with a rate corresponding to the operation amount of the inputting section 1 per a unit period of time, that is, the speed of operation of the inputting section 1.

The rate is set so that it increases as the speed of operation of the inputting section 1 increases. Further, a reference value is set for the speed of operation of the inputting section 1, and where the speed of operation of the inputting section 1 is equal to the reference value, the rate is set to 1, but where the speed of operation of the inputting section 1 is lower than the reference value, the rate is set to a value lower than 1. Therefore, preferably at least three different rates are prepared including the rate corresponding to the reference value, another rate corresponding to a speed of operation lower than the reference value and a further rate corresponding to a speed of operation higher than the reference value.

Consequently, when the operator operates the inputting section 1 slowly, the adjustment amount for the parameter is small, but when the operator operates the inputting section 1 quickly, the adjustment amount for the parameter is great. In other words, even if the operator operates the inputting section 1 by an equal amount, if the inputting section 1 is operated slowly, then the adjustment amount for the parameter is set to a low value with a low rate, but on the contrary, if the inputting section 1 is operated quickly, then the adjustment amount for the parameter is set to a high value with a high rate.

This rate is set as a table 40 in advance in accordance with a relationship to the operation amount (speed) of the inputting section 1 per a unit period of time. The table 40 may be provided corresponding to the graduation display section 3 such that the operator can rewrite the table 40.

The movement amount decision section 5 performs processes of deciding the amount of movement for the knob display of the graduation display section 3 in accordance with the adjustment amount for the parameter decided by the arithmetic operation section 4 and deciding the amount of movement for the pointer in accordance with the amount of movement for the knob display. When the adjustment amount for the parameter is decided by the arithmetic operation section 4, the position of the knob display with respect to the rail of the graduation display section 3 is decided in accordance with the adjustment amount for the parameter. Accordingly, the position of the knob display is determined in accordance with the position of the parameter set on the rail. Further, the movement amount decision section 5 decides the display position of the pointer so as to coincide with the position of the knob display decided formerly.

In other words, in the present embodiment, when the knob display on the rail of the graduation display section 3 is designated by the pointer and the knob display is moved on the rail by an operation of the inputting section 1 to perform adjustment of the parameter, the operation amount of the inputting section 1 is converted into an adjustment amount for the parameter and the position of the knob display is decided from the adjustment, and in this condition, the position of the pointer is decided in accordance with the decided position of the knob display. Accordingly, when the parameter is to be adjusted on the graduation display section 3, the operation of the inputting section 1 is directly reflected on the adjustment of the parameter, and the pointer follows up in accordance with the adjustment. Therefore, when the knob display on the rail is moved to adjust the parameter, the sense of the operator takes precedence.

It is to be noted that, in the conventional technique, an operation of an inputting section such as a mouse is reflected directly on the movement of a pointer, and a knob display moves in such a manner as to follow up the position of the pointer. Therefore, the amount of movement for the knob display, that is, the adjustment amount for the parameter, is decided from the amount of movement for the pointer, and the adjustment cannot necessarily be performed in accordance with a range of the graduation display section. In contrast, in the present embodiment, since the operation amount of the inputting section is reflected directly on the adjustment amount for the parameter, the adjustment can be performed in accordance with the range of the graduation display section.

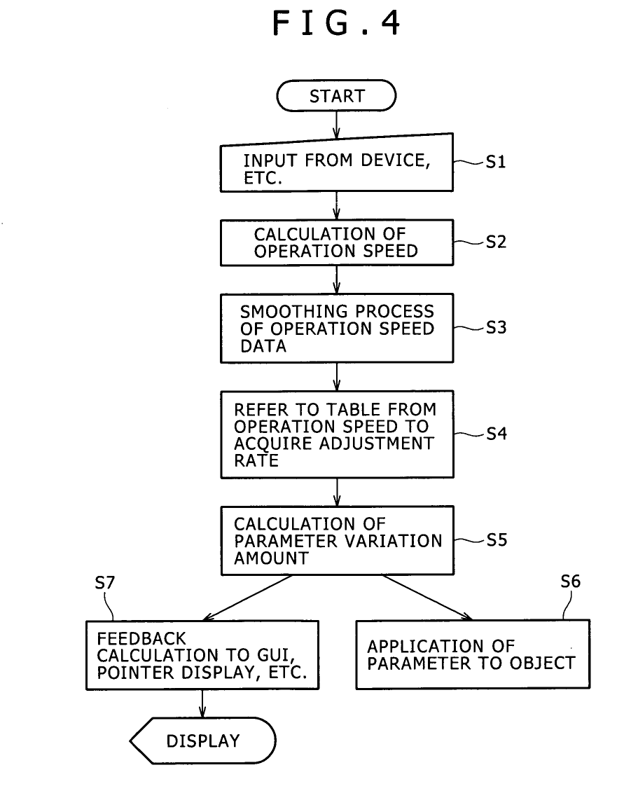

It is to be noted that the processes performed by the detection section 2, graduation display section 3, arithmetic operation section 4, movement amount decision section 5 and pointer control section 6 from among the components described hereinabove can be implemented by program processes executed by a CPU (central processing unit) 100. Now, an editing processing program according to the present embodiment is described with reference to FIGS. 1 and 4.

FIG. 4 is a flow chart illustrating the editing processing program according to the present embodiment. First, if the inputting section (device) 1 is operated by the operator (step S1), then an operation amount of the device is detected by and passed from the detection section 2 to the arithmetic operation section 4.

The arithmetic operation section 4 calculates the speed of the operation (amount of movement per a unit period of time) of the device (step S2). Further, the arithmetic operation section 4 tabulates a number of data of the operation speed of the device equal to a predetermined number of sampling pulses to smooth the data (step S3).

Then, the arithmetic operation section 4 refers to the table 40 from the calculated speed of operation of the device to acquire an adjustment rate corresponding to the speed of operation (step S4). Thereafter, the arithmetic operation section 4 calculates a variation amount (adjustment amount) of the parameter in accordance with the acquired adjustment rate (step S5) and adapts the parameter to the object of the adjustment (step S6).

Then, the movement amount decision section 5 decides the position of the knob display in accordance with the adjustment amount for the parameter and performs feedback calculation of the position of the pointer in accordance with the decided position of the knob display (step S7).

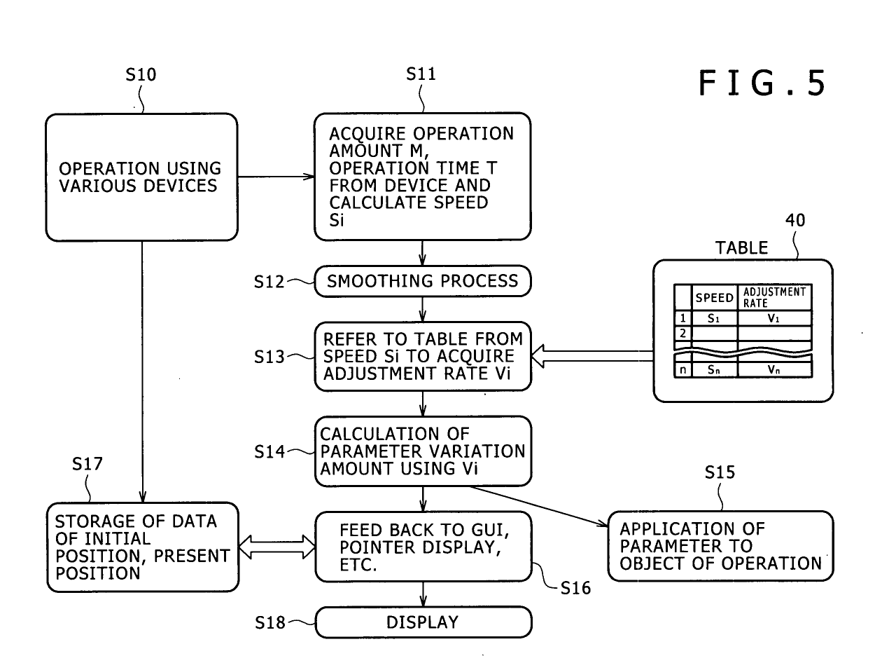

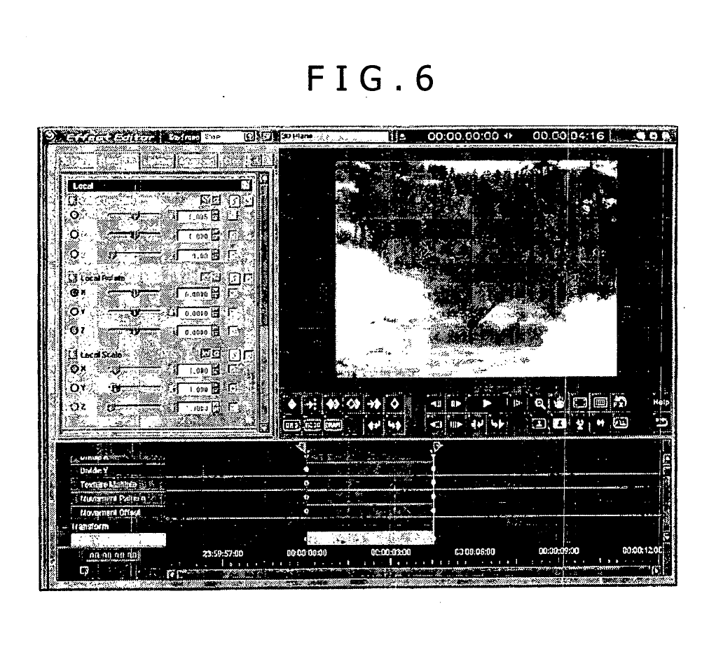

FIG. 5 is a flow chart illustrating a particular flow of processes of the editing processing program according to the present embodiment. Referring to FIG. 5, when the operator operates any of the various devices (step S10), then the arithmetic operation section 4 acquires an operation amount M and operation time T of the device and calculates the speed Si of the operation of the device (step S11).

Then, the arithmetic operation section 4 performs a smoothing process using the predetermined speed Si (step S12) and then refers to the table 40 from the speed Si after smoothed to acquire an adjustment rate Vi corresponding to the speed Si (step S13).

Thereafter, the arithmetic operation section 4 calculates the variation amount of the parameter using the acquired adjustment rate Vi (step S14) and applies the calculated variation amount of the parameter to the object of the operation (step S15).

On the other hand, the movement amount decision section 5 calculates the position of the knob display based on the adjustment amount for the parameter decided by the arithmetic operation section 4 and performs feedback calculation of the position of the pointer in accordance with the position of the knob display (step S16). Then, the movement amount decision section 5 stores data of the initial position and the position at present with regard to the knob display and the pointer (step S17). Then, the movement amount decision section 5 displays the knob display and the pointer on the display unit 10 (step S18).

By such processes as described above, in adjustment of the parameter where the graduation display section 3 such as a slider is used, adjustment of the parameter can be performed at an adjustment rate conforming to the speed of operation of a device by the operator. Thus, an interface having a higher degree of fidelity to the sense of a human being can be achieved.

It is to be noted that the editing processing program according to the present embodiment described above is implemented by being incorporated in an operating system or an application program executed by a computer, or is recorded in a predetermined medium such as a CD-ROM or the like, or else is distributed through a network.

Further, while, in the example described above, an adjustment rate corresponding to the speed of operation of the device is determined by reference to the table 40, it may otherwise be determined by arithmetic operation using a predetermined relational expression. Further, while, when the knob display of the graduation display section 3 is moved, also the pointer is moved together, when the knob display is moved, only the knob display may be moved by the inputting section 1 without interlocking with movement of the pointer.

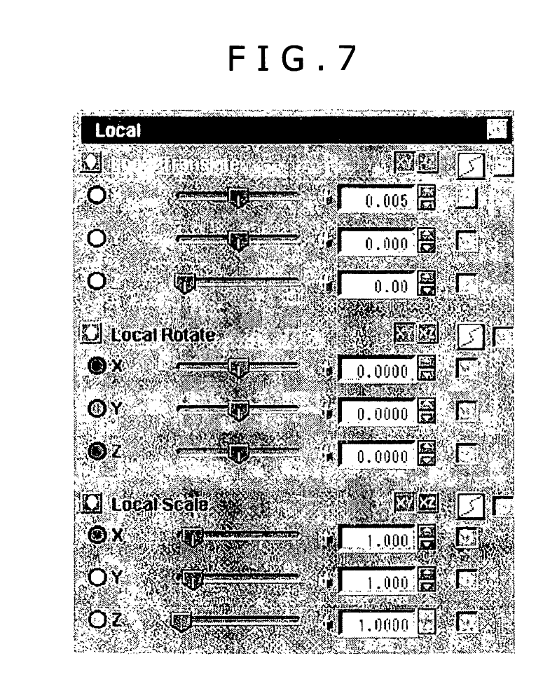

FIG. 6 shows an example of a screen display of an editing processing application to which the present invention is applied, and FIG. 7 is an enlarged view of sliders for parameter adjustment displayed on the screen. In the editing processing application, an image of an object of editing is displayed at an upper right portion of the screen shown in FIG. 6, and graduations of a timer counter are displayed at a lower portion of the screen.

The operator can grasp lapse of time of an image displayed currently on the screen, and if the operator designates an arbitrary position of the graduations of the time counter by means of the inputting device, then an image corresponding to the time count is displayed in a window. Various operation buttons such as an image reproduction button, a pause button, a fast feed button and a rewiring button and various other operation buttons such as operation buttons for partial expansion and reduction and movement of an image and so forth are displayed on the lower side of the window for displaying an image. The operator can selectively operate the operation buttons to perform a desired operation relating to image display.

Parameter adjusting sliders for applying various processes to a displayed image are displayed on the left side on the screen. The sliders shown in FIGS. 6 and 7 are for adjusting parameters to be used for deformation of the display image or a selected region in the image. In the example shown in FIGS. 6 and 7, three parameters for three directions including an X direction, a Y direction and a Z direction can be adjusted for each of “Local Translate”, “Local Rotate” and “Local Scale”.

The sliders provided for the parameters have an equal length but have ranges from a minimum value to a maximum value which are set suitably depending upon the individual parameters. In the present embodiment, different tables or functions for an adjustment rate are prepared for the individual sliders, or tables or functions having adjustment rates which are different for different ranges are prepared.

The operator would select a slider of a desired parameter to be made an object of image processing and move the knob display of the selected slider by means of the inputting device. The value of the parameter is displayed in a numerical value window positioned alongside the slider, and the value of the parameter which is set in an interlocking relationship with the movement of the knob display is displayed in the numerical value window. Further, if the parameter is changed as a result of movement of the knob display, then the image is deformed in accordance with the change so that a variation in state of the image caused by adjustment of the parameter can be recognized.

Where the present embodiment is applied to such parameter adjustment as described above, a table or a function corresponding to the parameter selected as an object of adjustment is used to establish a coordinated relationship between the speed of operation of the inputting device and the adjustment rate.

Consequently, if the operator moves the inputting device slowly, then the parameter can be adjusted at fine pitches, but on the contrary if the inputting device is moved quickly, then the parameter can be adjusted at great pitches.

For example, where such a table as illustrated in FIG. 3 is used, the speed of movement of the inputting device is classified into five stages such that “3” is applied to a standard speed and “1” is applied to the lowest speed while “5” is applied to the highest speed, and the adjustment rate is set for each of the stages. Here, it is assumed that, in such sliders as shown in FIG. 7, for example, the rail has a span of 50 mm to each of the left and right sides from the center hereof. Further, it is assumed that each parameter has a range from a minimum value of −50 to a maximum value of +50, and the minimum resolution is 1/1000 (to three places of decimals). Also it is assumed that the knob display is at the center position of the rail, and the parameter indicates 0.

If the operator uses the inputting device to move the knob display on such a slider as described above, then the arithmetic operation section 4 first calculates the speed of movement of the inputting device. If the speed is the standard speed, then the adjustment rate of “1” is selected. At the adjustment rate of “1”, since the amount of movement of the inputting device and the amount of adjustment for the parameter have the relationship of 1:1, if the inputting device is moved, for example, by 10 mm rightwardly (in the + direction), then also the knob display moves by 10 mm, and the parameter changes to a value corresponding to 10 mm on the rail, here, to +10.

On the other hand, if the speed of movement of the inputting device is the stage “5”, then another adjustment rate of “25” is selected. At the adjustment rate of “25”, the amount of movement of the inputting device and the amount of adjustment of the parameter have a relationship of 1:25. Therefore, if the inputting device is moved, for example, by 2 mm rightwardly (in the + direction), then the knob display moves by 50 mm which is equal to 25 times. Consequently, the parameter changes to a value corresponding to a value corresponding to 50 mm on the rail, that is, to +50.

However, if the speed of movement of the inputting device is the stage “1”, then a further adjustment rate of “0.01” is selected. At the adjustment rate of “0.01”, the amount of movement of the inputting device and the amount of adjustment for the parameter have a relationship of 1:0.01. Therefore, if the inputting device is moved, for example, by 2 mm rightwardly (in the + direction), then the knob display moves by 0.02 mm which is equal to 0.01 time. Consequently, the parameter changes to a value corresponding to 0.02 mm on the rail, that is, to +0.02.

In this manner, in the present embodiment, an adjustment amount for a parameter is arithmetically operated from the amount of movement and the speed of movement of the inputting device first, and then the position of the knob display is decided in accordance with the adjustment amount for the parameter, and thereafter the position of the pointer is decided in accordance with the position of the knob display. Therefore, where the operator desires to perform, for example, movement of a very small amount, if the operator moves the inputting device slowly, then although the amount of movement of the inputting device is great, the amount of variation of the parameter is small. Consequently, fine parameter setting can be performed readily.

Further, at this time, since the pointer moves together with the movement of the knob display irrespective of the amount of movement of the inputting device, for example, when the inputting device actually moves, if the amount of movement of the inputting device is very small, then the knob display may exhibit no position variation. Thereupon, also the position of the pointer does not change either.

As described above, in the present embodiment, the amount of movement of the inputting device is converted into an amount of adjustment of a parameter such that, if the inputting device is moved slowly, then very fine adjustment of the parameter can be performed, but if the inputting device is moved quickly, then the parameter can be changed by a great amount. Therefore, an editing operation which conveniently conforms to the sense of the operator can be performed.

While preferred embodiments of the present invention have been described using specific terms, such description is for illustrative purposes only, and it is to be understood that changes and variations may be made without departing from the spirit or scope of the following claims.

What is claimed is:

1. An editing apparatus, comprising:
an inputting section for operating the position of a pointer to be displayed on a screen;
a detection section for detecting the operation amount of said inputting section by an operator;
a graduation display section displayed on said screen and including a knob display which moves together with the pointer to adjust a parameter of an object of editing;
an arithmetic operation section for deciding an amount of adjustment for the parameter based on the operation mount of said inputting section detected by said detection section; and
a movement amount decision section for deciding an amount of movement for the knob display of said graduation display section in accordance with the amount of adjustment for the parameter determined by said arithmetic operation section and deciding an amount of movement for the pointer in accordance with the decided amount of movement.

2. The editing apparatus according to claim 1, wherein said arithmetic operation section decides the amount of adjustment for the parameter in accordance with a rate corresponding to the amount of operation of said inputting section per a unit period of time.

3. The editing apparatus according to claim 2, wherein the rate increases as the amount of operation of said inputting section per a unit period of time increases.

4. The editing apparatus according to claim 2, wherein the rate is equal to 1 where the amount of operation of said inputting section per a unit period of time is equal to a reference value, but is lower than 1 where the amount of operation of said inputting section per the unit period of time is lower than the reference value.

5. The editing apparatus according to claim 2, wherein the rate can assume at least three stages among a case wherein the amount of operation of said inputting section per a unit period of time is equal to the reference value, another case wherein the amount of operation of said inputting section per the unit period of time is higher than the reference value and a further case wherein the amount of operation of said inputting section per the unit period of time is lower than the reference value.

6. The editing apparatus according to claim 2, wherein said arithmetic operation section determines said rate by arithmetic operation of a relational expression from the amount of operation of said inputting section per a unit period of time.

7. An editing processing program for causing a computer to execute a process of performing adjustment of a parameter of an object of editing by allowing the position of a pointer displayed on a screen to be moved by means of an inputting section for being operated by an operator and moving a knob display of a graduation display section together with the movement of the pointer, comprising the steps of:
detecting an operation amount of said inputting section by the operator;
deciding an amount of adjustment for the parameter based on the operation mount of said inputting section detected by the process at the detection step; and
deciding an amount of movement for the knob display of said graduation display section in accordance with the amount of adjustment for the parameter decided by the process at the decision step and deciding an amount of movement for the pointer in accordance with the decided amount of movement.

8. An editing apparatus, comprising:
a graduation display section displayed on a screen and including a knob display which is moved to adjust a parameter of an object of editing;
an inputting section for operating the position of the knob display of said graduation display section;
a detection section for detecting an operation amount of said inputting section by an operator;
an arithmetic operation section for deciding an amount of adjustment for the parameter based on the operation amount of said inputting section detected by said detection section; and
a movement amount decision section for deciding an amount of movement for the knob display of said graduation display section in accordance with the amount of adjustment for the parameter decided by said arithmetic operation section;
said arithmetic operation section deciding the amount of movement for the parameter in accordance with a rate corresponding to the amount of operation of said inputting section per a unit period of time.

9. An editing processing program for causing a computer to execute a process of performing adjustment of a parameter of an object of editing depending upon the position of a knob display on a graduation display section displayed on a screen as a result of movement of the knob display by means of an inputting section for being operated by an operator, comprising the steps of:
detecting an operation amount of said inputting section by an operator;
deciding an amount of adjustment for the parameter based on the operation amount of said inputting section per a unit period of time detected by the process at the detection step and deciding the amount of adjustment for the parameter in accordance with the rate; and
deciding an amount of movement for the knob display of said graduation display section in accordance with the amount of adjustment for the parameter decided by the process at the decision step.
